(19) United States
(12) Patent Application Publication
(10) Pub. No.: US 2026/0187917 A1
(43) Pub. Date: Jul. 2, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Koji MAKITA, Kanagawa (JP); Masakazu FUJIKI, Kanagawa (JP)

(21) Appl. No.: 19/391,314

(22) Filed: Nov. 17, 2025

(30) Foreign Application Priority Data
Nov. 22, 2024 (JP) 2024-204301

(51) Int. Cl. G06T 17/00; G06T 19/00

(52) U.S. Cl. CPC G06T 17/00; G06T 19/00

(57) ABSTRACT

In an information processing apparatus, environment information such as an image relating to an environment is acquired, virtual content is generated based on the environment information, and the virtual content is updated based on the environment information to harmonize with the environment, thereby making it possible to generate virtual content that harmonizes with a surrounding landscape and the like.

### BACKGROUND

### Field of the Technology

The present disclosure relates to an information processing apparatus, an information processing method, and a storage medium.

### Description of the Related Art

For objects such as new buildings, furniture, artificial trees, and the like (hereinafter, referred to as “structures”), for which the cost of actually newly producing them is high, it is often the case that the design for the object is created in advance by computer graphics and its appearance is confirmed.

However, there is a drawback that the cost of the work for having a human design these structures is large. Therefore, conventionally, methods of automatically generating a design for the structures using a computer have been proposed.

For example, Japanese Patent Application Publication No. 2021-189848 discloses a method of automatically generating a design for a new three-dimensional model having characteristics similar to those of existing buildings.

Additionally, Japanese Patent Application Publication No. 2008-83728 discloses a method of automatically generating a design for a three-dimensional model in consideration of regulatory conditions imposed on land. Additionally, Japanese Patent Application Publication No. 2024-54680 describes a method of constructing and utilizing an object arrangement characteristic database. Additionally, the following Non-Patent Literatures 1 to 8 are also known.

### [Non-Patent Literature 1]

Ben Poole, et al., “DreamFusion: Text-to-3D using 2D Diffusion,” in arXiv, Sep. 2022
https://arxiv. org/abs/2209.14988
[Non-Patent Literature 2]
Honma, et al., “Study on Quantification of ‘Kyoto-like’ Features in Night Landscape,” Historical City Disaster Prevention Papers, Vol. 17 (July 2023) https://ritsumei. repo. nii. ac. jp/record/2000218/files/dmuch_17_honma. pdf

### [Non-Patent Literature 3]

Jiaxiang Tang, et al., “DreamGaussian: Generative Gaussian Splatting for Efficient 3D Content Creation,” in arXiv, Mar. 2024
https://arxiv. org/abs/2309.16653

### [Non-Patent Literature 4]

Junnan Li, et al., “BLIP: Bootstrapping Language-Image Pre-training for Unified Vision-Language Understanding and Generation,” in arXiv, Feb. 2022
https://arxiv.org/pdf/2201.12086

### [Non-patent Literature 5]

Ben Mildenhall, et al., “NeRF: Representing Scenes as Neural Radiance Fields for View Synthesis,” in arXiv, Aug. 2020
https://arxiv.org/pdf/2003.08934

### [Non-Patent Literature 6]

Bernhard Kerbl, et al., “3D Gaussian Splatting for Real-Time Radiance Field Rendering,” in arXiv, Aug. 2023
https://arxiv.org/pdf/2308.04079

### [Non-Patent Literature 7]

Kotani, et al., “AR Authoring System Considering the Shape of an Annotated Object,” Information Science and Technology Forum General Lecture Proceedings, 5(3), 429-430 (Aug. 21, 2006)
https://ipsj.ixsq.nii.ac.jp/e/?
action=repository_uri&item_id=156627&file_id=1&file_no=1

### [Non-Patent Literature 8]

Ao Wang, et al., “YOLOv10: Real-Time End-to-End Object Detection,” in arXiv, May 2024
https://arxiv.org/pdf/2405.14458

However, in the conventional methods as described above, there are cases in which the generated design of the structure does not harmonize with the surrounding landscape.

### SUMMARY

An information processing apparatus according to an embodiment of the present disclosure comprises: at least one processor; and a memory coupled to the at least one processor, the memory storing instructions that, when executed by the at least one processor, cause the at least one processor to: acquire environment information; generate virtual content based on the environment information; and update the virtual content to harmonize with the environment based on the environment information.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of a hardware configuration of an information processing apparatus according to a first embodiment of the present disclosure.

FIG. 2 is a conceptual diagram illustrating an example of a scene in which virtual content is generated in the first embodiment.

FIG. 3 is a functional block diagram illustrating an example of a logical configuration of the information processing apparatus 1 in the first embodiment.

FIG. 4 is a flowchart illustrating an example of processing for an information processing method using the information processing apparatus 1 in the first embodiment.

FIG. 5 is a functional block diagram illustrating an example of a logical configuration of the information processing apparatus 200 in a second embodiment.

FIG. 6 is a flowchart illustrating an example of processing for an information processing method using the information processing apparatus 200 in the second embodiment.

FIG. 7 is a flowchart illustrating an example of detailed processing of step S2040 in FIG. 6.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate descriptions thereof will be omitted or simplified.

### First Embodiment

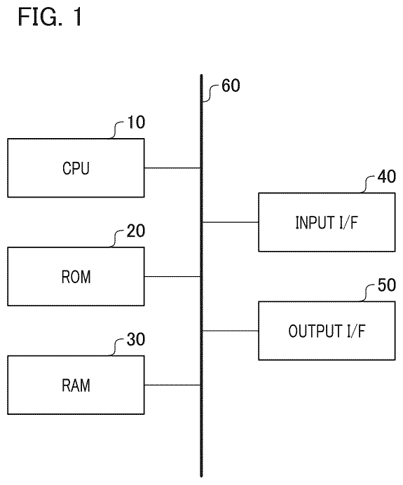

FIG. 1 is a diagram illustrating an example of a hardware configuration of an information processing apparatus according to a first embodiment of the present disclosure. A CPU 10 serving as a computer controls each unit that is connected to a bus 60 via the bus 60.

An input interface (I/F) 40 acquires an input signal in a format that is processable by the information processing apparatus, from an external device (such as an imaging apparatus, a display device, or an operation device). Additionally, an output I/F 50 outputs an output signal in a format that is processable by an external device (such as a display device), to the external device.

A computer program for realizing the functions of the respective embodiments is stored in a storage medium such as a read-only memory (ROM) 20. Additionally, the ROM 20 stores an operating system (OS) and a device driver.

A random access memory (RAM) 30 temporarily stores these programs. By executing the computer program stored in the RAM 30, the CPU 10 executes, for example, processing according to each flowchart to be described below and realizes the functions of the respective embodiments.

Note that the functions of the respective embodiments may also be realized by using hardware having arithmetic units or circuits corresponding to the processing of the functional units, instead of software processing using the CPU 10.

In the first embodiment, an example will be explained in which a Mixed Reality (MR) system (hereinafter, referred to as “MR system”) is used as the external device. Additionally, although the virtual content that the user desires to generate will be explained as being, for example, a building, the virtual content is not limited to buildings.

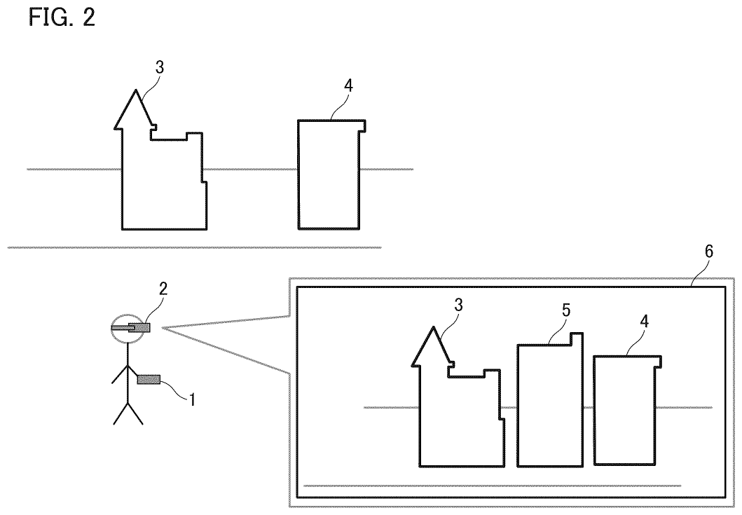

FIG. 2 is a conceptual diagram illustrating an example of a scene in which the information processing apparatus in the first embodiment generates virtual content. An MR system 2, serving as an external device, photographs a surrounding environment by using a camera mounted on a head-mounted display that is included in the MR system 2, and generates information for the surrounding environment (hereinafter, referred to as “environment information”) based on the captured image.

The information processing apparatus 1, which is the subject of the present embodiment, inputs the environment information generated by the MR system 2, generates and updates virtual content 5 that harmonizes with the surrounding environment, and transmits the virtual content 5 to the MR system 2. A structure 3 and a structure 4 are structures that exist+in the real environment.

Next, the MR system 2 inputs the virtual content 5, generates an image 6 in which the image of the real environment captured by the camera (for example, the structures 3 and 4) and the virtual content 5 are combined (hereinafter, referred to as “MR image”), and displays the MR image on the head-mounted display. A user of the MR system 2 can confirm the appearance of the generated virtual content together with the real environment by observing the image 6 through the head-mounted display.

The virtual content that is generated and confirmed by the MR system 2 is model data holding a three-dimensional shape and texture, and can be used as design data for creating an actual building and the like.

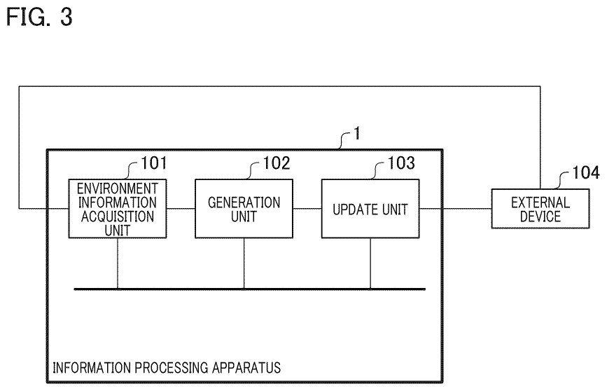

FIG. 3 is a functional block diagram illustrating an example of a logical configuration of the information processing apparatus 1 in the first embodiment. It should be noted that part of the functional blocks shown in FIG. 3 are realized by causing the CPU, which serves as a computer that is included in the information processing apparatus 1, to execute a computer program stored on a memory that serves as a storage medium.

However, part or all of the functional blocks may alternatively be realized by hardware. As the hardware, a private circuit (ASIC), a processor (such as a reconfigurable processor or a DSP), and the like can be used.

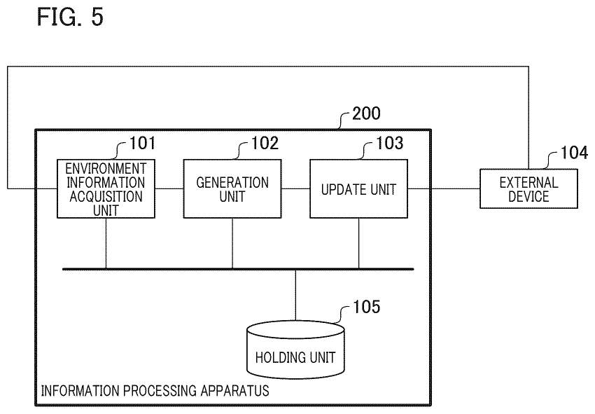

Additionally, each of the functional blocks shown in FIG. 3 need not be housed in the same casing and may be constituted by separate devices that are connected to each other via signal lines. It should be noted that the above explanation concerning FIG. 3 similarly applies to FIG. 5.

The information processing apparatus 1 includes an environment information acquisition unit 101, a generation unit 102, and an update unit 103. The environment information acquisition unit 101 and the update unit 103 are connected to an external device 104 (for example, the MR system 2). The environment information acquisition unit 101 functions as an environment information acquisition unit and acquires environment information relating to the environment stored by the external device 104.

The generation unit 102 functions as a generation unit and generates virtual content based on the environment information acquired by the environment information acquisition unit 101. In the present embodiment, since virtual content is generated by using a generative AI, the generation unit 102 holds a generative AI model for generating virtual content.

The update unit 103 inputs and updates the virtual content that is generated by the generation unit 102. In the present embodiment, since the virtual content is updated by using a generative AI, the update unit 103 holds a generative AI model for updating virtual content.

It should be noted that the update unit 103 functions as an update unit that updates the virtual content to harmonize with the environment based on the environment information. The external device 104 transmits environment information to the information processing apparatus 1. Additionally, the external device 104 acquires virtual content from the information processing apparatus 1.

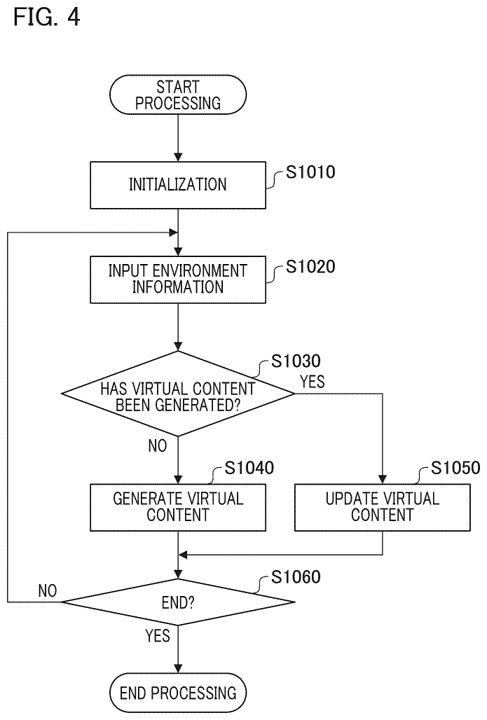

FIG. 4 is a flowchart illustrating an example of processing for an information processing method using the information processing apparatus in the first embodiment. It should be noted that the operations of the respective steps in the flowchart of FIG. 4 are sequentially executed by causing a CPU, which serves as a computer of the information processing apparatus 1, to execute a computer program that is stored on a memory.

It should be noted that the processing procedure of the flowchart to be described hereinafter is not limited to the illustrated example, and any combination of procedures, consolidation of multiple processes, or segmentation of processes is possible as long as the results of the present embodiment are satisfied. Additionally, each process may be individually extracted to function as a single functional element and may be used in combination with processing other than the illustrated processing.

In a case in which an instruction to display virtual content is input from a user by an input unit (not illustrated) of the MR system 2, the processing flow of FIG. 4 starts. Then, in step S1010, initialization processing is performed to bring the information processing apparatus 1 into an operable state.

Note that in the present embodiment, virtual content is generated or updated using a generative AI in step S1040 and step S1050. Therefore, in step S1010, each of the generation unit 102 and the update unit 103 performs processing of loading the structure data and weight parameters for this generative AI model onto a memory.

In step S1020, the environment information acquisition unit 101 acquires environment information from the external device 104. Here, the environment information includes the positions of objects that exist in the environment and the categories of the objects, and in the present embodiment, the environment information is information that is continuously updated in real time by the MR system 2, which serves as the external device. It should be noted that step S1020 functions as an environment information acquisition step of acquiring environment information relating to the environment.

In step S1030, the generation unit 102 determines whether or not the virtual content has already been generated. In a case in which the virtual content has not been generated, the process proceeds to step S1040. In a case in which the virtual content has already been generated, the process proceeds to step S1050.

In step S1040, the generation unit 102 generates virtual content by using the environment information acquired from the external device 104 by the environment information acquisition unit 101. In the present embodiment, to generate virtual content, the method that is described in Non-Patent Literature 1 is used, in which text information (hereinafter, referred to as a “prompt”) is input and a three-dimensional model is generated. In this context, step S1040 functions as a generation step of generating virtual content based on the environment information.

In this step, first, the number of buildings that are included in the environment information is tabulated for each category, and a prompt instructing the generation of a building that harmonizes with the landscape in which the category that has the maximum number of buildings is most common.

As an example, in a case in which the category that has the maximum number of buildings is “temple,” a character string such as “generate a three-dimensional model of a building that harmonizes with a landscape in which a large number of temples are present” is generated as the prompt.

Next, the prompt that has been generated is input into the generative AI model, a three-dimensional model is generated, and the process proceeds to step S1060. As described above, in the present embodiment, the generation unit generates text information (prompts) for generating virtual content that harmonizes with the environment based on information relating to the environment, and generates virtual content based on the text information (prompt) by using the generative AI model.

Note that, here, it is assumed that the position and orientation of a building that serves as the virtual content in the real environment are automatically estimated by the MR system 2. However, the user of the MR system 2 may, while viewing the MR image, use a user interface and the like to place the virtual content at a desired position and orientation, or may adjust the position and orientation that has been automatically estimated by the MR system 2.

In step S1050, the update unit 103 updates the virtual content. Here, step S1050 functions as an update step of updating the virtual content so as to harmonize with the environment based on the environment information.

Note that in step S1050, first, a degree of harmony (hereinafter, referred to as the “degree of harmony”) between the virtual content and the environment is calculated. Next, a prompt is generated based on the calculation result of the degree of harmony, and the prompt is input into the generative AI model in order to update the three-dimensional model that was generated in step S1040 and the like.

That is, in step S1050, the update unit calculates the degree of harmony of the virtual content with respect to the environment based on the environment information, and updates the virtual content so as to harmonize with the environment based on the degree of harmony. Note that the updating of the three-dimensional model may be performed by using the method described in Non-Patent Literature 1.

In the present embodiment, the external device 104 (the MR system 2) acquires virtual content from the update unit 103, synthesizes the virtual content with an image that was obtained by photographing the real environment (hereinafter, referred to as a “real image”), and generates an MR image.

Next, the update unit 103 acquires the real image and the MR image from the external device 104 (the MR system 2). Furthermore, the update unit 103 calculates a difference in color distribution between the real image and the MR image by using the method described in Non-Patent Literature 2.

Finally, a prompt for updating the current virtual content is generated based on the difference in color distribution. Specifically, color tones are divided, for example, into 11 types (red, pink, orange, yellow, green, blue, purple, brown, white, gray, and black), and the difference in color distribution in each tone is calculated.

Next, a color tone for which the magnitude of the difference in color distribution is equal to or greater than a threshold is detected. Finally, for each of the detected color tones, a prompt for updating the virtual content is generated to increase colors that are more included in the real image and to decrease colors that are more included in the MR image.

As an example, in a case in which the color tones for which the magnitude of the difference is equal to or greater than the threshold are brown and pink, and brown is a color that is more included in the real image while pink is a color that is more included in the MR image, a prompt such as “increase brown and decrease pink” is generated. Next, the created prompt and the virtual content are input, the virtual content is updated, and the process proceeds to step S1060.

In step S1060, it is determined whether or not to terminate the processing flow of FIG. 4. In a case in which a termination instruction is input from a user by the input unit (not illustrated) of the MR system 2, the virtual content that was generated in step S1040 and the virtual content that was updated in step S1050 is stored, and the processing flow of FIG. 4 is terminated.

Otherwise, the process returns to step S1020, and the processing from step S1020 to step S1060 is repeatedly executed. According to the method of the present embodiment, it is possible to generate a design of a structure that harmonizes with the surrounding landscape (for example, color distribution).

### Modified Example 1-1

Although in the present embodiment, environment information is input into the generation unit at the time of generating virtual content, generation conditions for the virtual content may also be additionally input. Here, the generation conditions for the virtual content are information that determines the appearance of the virtual content, and relates to the color, size, shape, position, orientation, and the like of the virtual content.

For example, the size of the virtual content, which is designated by a user as a generation condition, is input into the generation unit and the update unit, and the generation unit and the update unit generate and update the virtual content so that the virtual content has the designated size. At this time, the size of the virtual content is numerically input as the lengths of three sides of a cuboid circumscribing the virtual content.

Alternatively, by using a user interface mounted on the MR system 2, primitives such as cuboids or cylinders are placed in the MR space, thereby setting the size of the virtual content. Alternatively, by using the method that is described in Non-Patent Literature 7, a two-dimensional region is input from a plurality of positions and orientations to set a view volume, and the size of the virtual content is set by setting a region in which the virtual content exists.

Alternatively, a two-dimensional image including outward appearance (appearance) features (at least one of color, size, shape, position, orientation, and the like) of the virtual content to be generated may be added to the environment information. Then, the generation unit extracts a word or sentence indicating the appearance features of the two-dimensional image and generates a prompt including the word or sentence.

It should be noted that as a method of extracting a word or sentence indicating the outward appearance (appearance) features (at least one of color, size, shape, position, orientation, and the like) of a two-dimensional image for example, the method that is described in Non-Patent Literature 4 is employed. By specifying the generation conditions for the virtual content as described above, the appearance of the virtual content can be set so as to be closer to the appearance that is desired by the user.

As described above, the generation unit may generate virtual content based on generation conditions relating to at least one or more of the color, shape, position, and orientation of the virtual content.

### Modified Example 1-2

Although in the present embodiment, when generating virtual content, environment information that has been acquired by the MR system 2 is input into the generation unit, in addition, information relating to a category of the virtual content may also be used.

For example, a prompt relating to a category of content to be generated is held in a holding unit (not illustrated) of the information processing apparatus, and when generating a prompt, the generation unit 102 generates a prompt including this category.

In a case in which the category that is held is “convenience store,” the generation unit 102 generates a prompt such as “generate a three-dimensional model of a convenience store that harmonizes with a landscape in which a large number of temples are present”, and virtual content is thereby generated based on the prompt.

As described above, by using categories, virtual content can be generated using a prompt that specifies a category desired by a user.

### Modified Example 1-3

In the present embodiment, the environment information that is acquired by the environment information acquisition unit 101 is generated by a camera mounted on the external device 104, which is the MR system. However, as long as the information includes the positions and categories of objects in the environment, it may be generated by a device other than the MR system 2.

That is, for example, positions and categories of objects around an information terminal such as a smartphone or tablet may be recognized based on information obtained by a camera or a position/orientation sensor that has been mounted on the smartphone or tablet, and the recognition results may be used as environment information.

Alternatively, environment information that has been generated using image recognition technology by recognizing positions and categories of objects from an image obtained by an arbitrary viewpoint image generation technique may be used. For example, the method described in Non-Patent Literature 5 or Non-Patent Literature 6 may be used for generating an arbitrary viewpoint image,.

Alternatively, an image that has been rendered from data obtained by three-dimensional reconstruction of an environment using a three-dimensional reconstruction technique such as photogrammetry, or an image that has been retrieved from a database in which a two-dimensional image group is stored together with image-capturing positions and orientations, may be used as the environment information.

Additionally, the environment information may be extracted from map data such as car navigation data, which includes information on the positions and categories of objects. As described above, the method of generation for the environment information is not limited, and environment information generated by various methods may be utilized.

### Modified Example 1-4

Although in the present embodiment, the virtual content to be generated has been explained as being a building, the present disclosure is not limited thereto, and the virtual content may also be another object.

For example, in a case in which the virtual content to be generated is furniture, in step S1040 described in FIG. 4, a character string such as “generate a three-dimensional model of furniture that harmonizes with a room in which a large number of chairs are present” is created as a prompt. Furthermore, in step S1050 described in FIG. 4, a character string such as “increase yellow” is created as a prompt.

Alternatively, in a case in which the virtual content to be generated is a tree, in step S1040 described in FIG. 4, a character string such as “generate a three-dimensional model of a tree that harmonizes with a landscape in which a large number of buildings are present” is generated as a prompt.

Furthermore, in step S1050 described in FIG. 4, a character string such as “increase red autumn-colored trees” may be generated as a prompt. As described above, it is possible to use any type of virtual content regardless of the category thereof, and virtual contents of various categories can be generated and updated.

### Modified Example 1-5

Although in the present embodiment, in step S1050 described in FIG. 4, the degree of harmony is calculated using color distributions in the real environment and the virtual content, the present disclosure is not limited thereto. The degree of harmony may also be calculated using at least one element such as the color, shape, position, and orientation of the real environment information and the virtual content.

That is, the update unit may calculate the degree of harmony based on at least one of the color, shape, position, and orientation of the virtual content and the environment information and may update the virtual content such that the degree of harmony becomes higher.

As a method using color, as described in the first embodiment, one method is to use the difference in color distribution between a real image and an MR image, and to calculate the degree of harmony such that as the difference in color distribution becomes smaller, the degree of harmony becomes higher.

Alternatively, the degree of harmony may be calculated such that as the number of pixels in the MR image having saturation within a predetermined range becomes closer to a predetermined number, the degree of harmony becomes higher. Additionally, the degree of harmony may be calculated using shape. In that case, for example, the degree of harmony may be calculated based on the difference in height between the virtual content and an object (for example, a building) that exists in the real environment and is adjacent to the virtual content.

In a case in which the virtual content is a house, the degree of harmony may be calculated such that, as the shape and color of the roof between the real object and the virtual content become closer, from the perspective of townscape, the degree of harmony becomes higher. Alternatively, in a case in which the virtual content is furniture, the degree of harmony may be calculated such that as the difference in height between the real object and the virtual content becomes smaller, the degree of harmony becomes higher.

As a method using position, one method is to use the spatial distribution of objects that exist in the real environment and the virtual content. In a case in which the virtual content is a building, the degree of harmony may be calculated such that as the number of real buildings that exist within a predetermined distance from the virtual content increases, the degree of harmony becomes higher.

Alternatively, in a case in which the virtual content is furniture, the degree of harmony may be calculated such that, as the virtual furniture becomes closer to real furniture or building materials, the degree of harmony becomes higher.

As a method using orientation, one method is to use a difference in orientation between objects that exist in the real environment and the virtual content. In a case in which the virtual content is a building, the degree of harmony may be calculated such that, as the difference between the entrance direction of the virtual building and the entrance direction of a building that exists in the real environment and is adjacent to the virtual content becomes smaller, the degree of harmony becomes higher.

In a case in which the virtual content is a furniture shelf, the degree of harmony may be calculated such that as the difference in orientation between the virtual shelf and a shelf that exists in the real environment and is adjacent to the virtual shelf becomes smaller, the degree of harmony becomes higher. Alternatively, as another method using orientation, the degree of harmony may be calculated based on a ratio at which a part of the virtual content is visible (hereinafter referred to as a “visibility ratio”) in a case in which the virtual content has been placed in the environment.

In a case in which the virtual content is a building, the degree of harmony may be calculated such that as the visibility ratio of the entrance portion of the building becomes higher, the degree of harmony becomes higher. Alternatively, in a case in which the virtual content is furniture, the degree of harmony may be calculated such that as the visibility ratio of a rear portion of the furniture becomes lower, the degree of harmony becomes higher.

Additionally, the degree of harmony may be calculated by combining two or more elements from each of the degrees of harmony that were described above. For example, a weighted sum of the degree of harmony that was calculated using color and the degree of harmony that was calculated using shape may be used as the degree of harmony.

Additionally, a weighted sum of the degree of harmony that was calculated using position and the degree of harmony that was calculated using orientation may be used as the degree of harmony. By calculating the degree of harmony as described above, the degree of harmony can be calculated using the elements that are desired by a user, and the virtual content can be updated.

### Modified Example 1-6

In the present embodiment, the category of an object in the environment information may be segmented based on the appearance characteristics of the object. For example, if the object is a “temple,” it may be segmented into five types according to architectural style, namely, “Japanese style,” “Mixed style,” “Great Buddha style,” “Zen style,” and “Other.”

Additionally, if the object is furniture, it may be segmented into four types, namely, “Renaissance style,” “Baroque style,” “Rococo style,” and “Other.” Alternatively, segmentation may be performed using the color, size, or similar attributes.

Acquisition of the segmented categories is performed by object recognition from surrounding images that are used as environment information. For example, by using the method that was described in Non-Patent Literature 8, a deep learning model trained with a dataset corresponding to the segmented categories is created, and objects are recognized from surrounding images.

As described above, by segmenting object categories, virtual content that has been harmonized with the environment at a finer granularity can be generated and updated.

### Modified Example 1-7

The generation of virtual content may also be performed by using a three-dimensional model, which serves as an initial value, such as a three-dimensional model that is similar in appearance to the virtual content to be newly generated. The three-dimensional model that serves as an initial value may be input into the generation unit 102 by a user through a condition input unit (not illustrated) of the MR system 2. Additionally, the generation unit 102 generates virtual content by using the above-described three-dimensional model as an input.

The three-dimensional model that serves as an initial value is a model that is created manually by using modeling tools, and the like. Alternatively, it may be a model that is automatically generated by inputting a two-dimensional image. As a method of generating a three-dimensional model by inputting a two-dimensional image, for example, the method that was described in Non-Patent Literature 3 may be used.

To generate another three-dimensional model using the input three-dimensional model as an initial value, for example, the method described in Non-Patent Literature 1 is used. As described above, by utilizing the three-dimensional model that serves as an initial value, it is possible to generate virtual content that is closer to the desired appearance of the user and that has been updated to harmonize with the environment.

### Modified Example 1-8

In the present embodiment, in step S1050 described in FIG. 4, the degree of harmony is calculated using the color distributions for the real environment and the virtual content. However, for example, the degree of harmony may also be calculated based on the amount to which an image of a specific object is occluded by an image of the virtual content in a case in which the virtual content is placed in the environment (hereinafter, referred to as an “occlusion amount”).

For example, the degree of harmony may be calculated such that, as the occlusion amount outdoors of a famous castle, and of a painting that is displayed indoors becomes smaller, the degree of harmony becomes higher. Alternatively, when the object is equipment left on a rooftop that detracts from the landscape, the degree of harmony may be calculated such that a larger occlusion amount of rooftop facilities results in a higher degree of harmony.

The object that will serve as a target for the calculation of the occlusion amount is preselected by a user from among the objects that are included in the environment information. Alternatively, by using the method that was described in Non-Patent Literature 7, a two-dimensional region is input from a plurality of positions and orientations to set a view volume, and a region in which an object exists that serves as a target for calculation of the occlusion amount is set.

As described above, by utilizing the occlusion amount to calculate the degree of harmony, it is possible to generate or update virtual content so that an object that is intended to be noticeable becomes more noticeable. Additionally, it is possible to generate or update virtual content so that an object that is intended to not be noticeable becomes less noticeable.

### Modified Example 1-9

Although in the first embodiment, the range of the target for generating environment information is the entire environment, the present disclosure is not limited thereto, and the range may also cover just a partial region. For example, the entire two-dimensional image obtained by photographing the environment, a point cloud having three-dimensional coordinates generated by environmental measurement, and a three-dimensional mesh model may be the target.

Alternatively, by using a user interface that is capable of setting a region, a partial region of the above-described two-dimensional image, point cloud, and mesh model may be designated, and environment information may be generated with objects that are within the designated range as the targets.

As described above, by generating environment information, it is possible to generate and update virtual content that harmonizes with an environment in a range that is intended by a user.

### Modified Example 1-10

Although in the first embodiment, virtual content is updated by using a generative AI, the present disclosure is not limited thereto. For example, the parameters of the color, shape, position, and orientation of the virtual content may be directly updated based on the results of calculating the degree of harmony.

In a case in which a result is obtained by calculating the degree of harmony that indicates that it is preferable to increase brown and decrease pink in the virtual content, a portion of the points from among the points that are held by the virtual content that are not brown is selected and changed to brown. Additionally, a portion of the points that are pink is selected and changed to a non-pink color. Alternatively, a portion of the surfaces of the virtual content is selected and changed to brown.

Additionally, in a case in which a result is obtained by calculating the degree of harmony that indicates it is preferable to reduce the height of the virtual content, resizing of the virtual content is performed to reduce the height.

Additionally, in a case in which a result is obtained by calculating the degree of harmony that indicates it is preferable to change the position or orientation of the virtual content, the virtual content is changed to another position or orientation. As the other position or orientation, a position or orientation is used at which the degree of harmony is at its highest within a certain range of the real environment.

At that time, in the case of position, a plurality of candidate positions may be preset, and a position at which the degree of harmony is at its highest may be selected. Additionally, in the case of orientation, the virtual content may be rotated horizontally in increments of 90 degrees, and an orientation at which the degree of harmony is at its highest may be selected.

Updating the virtual content as described above results in updating the virtual content using elements desired by a user, such as color, shape, position, and orientation, without using a generative AI.

### Second Embodiment

In the first embodiment, the generation unit 102 generates virtual content by using a generative AI. In the present embodiment, by using an object arrangement characteristic database to be described below, one virtual content model is selected and output from among a plurality of three-dimensional models of virtual content, each having a category generated therefor in advance (hereinafter, referred to as “existing virtual content models”). As the virtual content model to be output, a building is explained as an example, similarly to the first embodiment.

FIG. 5 is a functional block diagram illustrating an example of a logical configuration of the information processing apparatus 200 in the second embodiment. Since the input/output data for the environment information acquisition unit 101, the update unit 103, and the external device 104 are similar to those of the first embodiment, explanations thereof will be omitted here. Since the holding unit 105 and the generation unit 102 are different from those of the first embodiment, the differences from the first embodiment will be explained.

The holding unit 105 holds an object arrangement characteristic database and a plurality of existing virtual content models. In this context, one existing virtual content model exists for each of a plurality of categories.

Additionally, the holding unit associates a plurality of virtual content models with categories for objects and position information, and holds these. The generation unit 102 selects and outputs one virtual content model from among the plurality of existing virtual content models that are held by the holding unit 105 based on the environment information.

The object arrangement characteristic database in the present embodiment is a database generated by deep learning of object arrangement characteristics consisting of categories and three-dimensional positions of objects that exist in an environment. The object arrangement characteristic database is constructed and used according to the method that was described in Japanese Patent Application Publication No. 2024-54680. Hereinafter, a method of constructing and using the object arrangement characteristic database will be explained.

The object arrangement characteristic database in the present embodiment is a pretrained neural network learned to infer unknown object arrangement characteristics from surrounding object arrangement characteristics. Specifically, it is a pretrained neural network in which a Transformer by Ashish et al. (“Attention is All You Need,” Ashish et al., NeurIPS 2017) is stacked in 24 layers.

In the present embodiment, the Transformer is configured such that the number of input dimensions and the number of output dimensions are 512, that is, up to 512 pieces of object characteristic information are input, and the same number of 512-dimensional outputs are obtained.

As the Transformer, for example, an encoder network used in the method of Jacob et al. (“BERT: Pre-training of Deep Bidirectional Transformers for Language Understanding,” arXiv 2018) is employed.

During the learning, correct information (hereinafter referred to as “ground truth information”) of categories and three-dimensional positions of objects existing in the environment is used. In the present embodiment, information extracted from map data for car navigation is used as the ground truth information. By completing the training, unknown object arrangement characteristics can be inferred based on the object arrangement characteristics of an environment in which the ground truth information has been acquired.

The goal of utilizing the object arrangement characteristic database is to obtain a plausible category for virtual content. Combined information of the environment information acquired by the environment information acquisition unit 101 in FIG. 5 and the information of the virtual content is input to the object arrangement characteristic database, and a plausible category of the virtual content is inferred. In the present embodiment, information with a known position and an unknown category is used as the information of the virtual content.

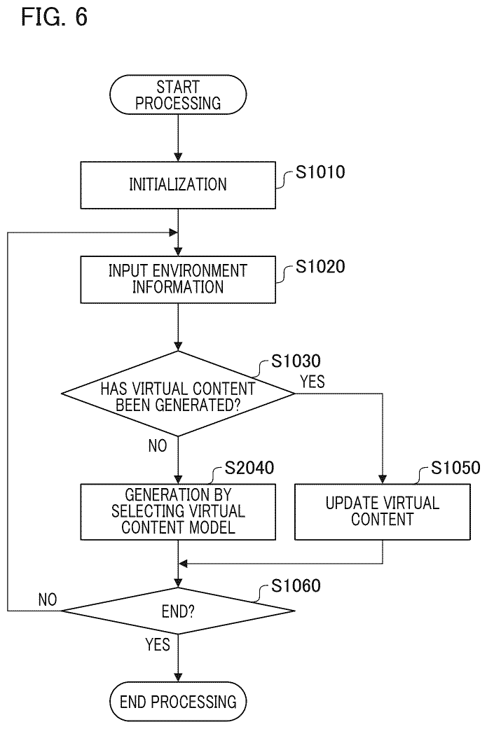

FIG. 6 is a flowchart illustrating an example of processing for an information processing method using the information processing apparatus 200 in the second embodiment. It should be noted that the operations of the respective steps in the flowchart of FIG. 6 are sequentially executed by causing a CPU, which serves as a computer of the information processing apparatus 1, to execute a computer program that has been stored in a memory.

Although the configuration of the flowchart in FIG. 6 is similar to that of the flowchart shown in FIG. 4 of the first embodiment, only the processing of step S2040 differs from that of the first embodiment, and therefore explanations of the processing other than the processing for step S2040 will be omitted.

In step S2040, the generation unit 102 uses the environment information that was acquired in step S1020 and the object arrangement characteristic database that is held by the holding unit 105 to select and output one virtual content model from among a plurality of existing virtual content models.

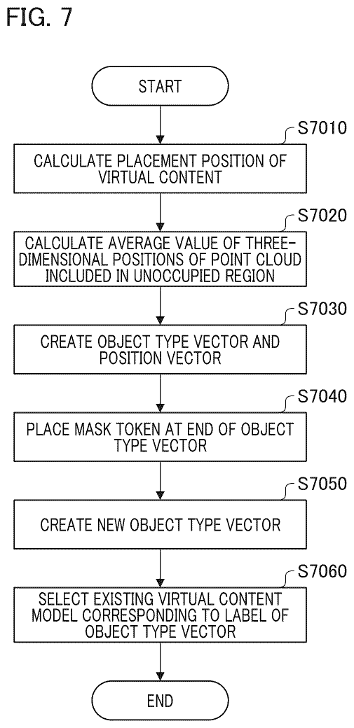

FIG. 7 is a flowchart illustrating an example of detailed processing for step S2040 in FIG. 6. An example of a method for selecting a virtual content model using the object arrangement characteristic database will be explained with reference to FIG. 7.

It should be noted that the operations of the respective steps in the flowchart of FIG. 7 are sequentially executed by causing a CPU, which serves as a computer of the information processing apparatus 1, to execute a computer program that has been stored in a memory.

In FIG. 7, in step S7010, an installation position of the virtual content is calculated. Specifically, first, an image of the environment that has been captured by a camera mounted on a head-mounted display of the MR system 2 is processed using semantic segmentation, and an unoccupied region on the two-dimensional image is detected.

Next, in step S7020, an average value for the three-dimensional positions of point cloud points that are included in the unoccupied region is used as the coordinates of the unoccupied region. The three-dimensional positions of the points of the point cloud that are included in the unoccupied region may be calculated by using, for example, the method described in the literature by Raul Mur-Artal et al. (“ORB-SLAM: A Versatile and Accurate Monocular SLAM System,” IEEE Transactions on Robotics).

Next, in step S7030, the environment information that was acquired by the environment information acquisition unit 101 is used to create an object type vector and a position vector. The object type vector is a one-dimensional column vector in which labels for categories of objects that exist in the environment are arranged.

For example, the first element of the object type vector is a CLS token (a special label indicating the beginning of data), followed by a label for a category of a first object that is included in the environment information, followed by a label of a category of a second object, and so on, so that labels for the categories of objects are arranged.

It should be noted that, in step S7030, at the end of the object type vector, a MASK token (a special label indicating that the object type is unknown) is placed as a label for the virtual content. The position vector is a vector in which the three-dimensional coordinates (X, Y, Z) of each object that is included in the environment information and the three-dimensional coordinates (X, Y, Z) of the virtual content are arranged as one-dimensional column vectors.

That is, each column of the position vector stores the X, Y, and Z values of the position coordinates of the object in the corresponding column of the object type vector, and at the end of the columns, the X, Y, and Z values of the three-dimensional position of the virtual content are stored. In this context, the X, Y, and Z values of the three-dimensional position of the virtual content are the three-dimensional position of the unoccupied region detected above.

Subsequently, in step S7040, the object type vector and the position vector that were created in step S7030 are input to the object arrangement characteristic database, and the type (category) of an object is predicted by prediction processing in the database. Then, in step S7050, a new object type vector is created in which the MASK token is updated to a label of the predicted type of the object.

Finally, in step S7060, an existing virtual content model corresponding to the label of the object type at the end of the new object type vector is selected from among the existing virtual content model group held by the holding unit 105. As a result, it is possible to automatically select a virtual content model of a plausible category, based on pre-learned data. After step S7060, the processing flow of FIG. 7 ends.

### Modified Example 2-1

Although in the second embodiment, information in which the position of the virtual content is known and the category is unknown is input into the object arrangement characteristic database in order to infer the category, the present disclosure is not limited thereto. Information in which the position of the virtual content is unknown and the category is known may be input into the object arrangement characteristic database in order to infer the position.

As a result, it is possible to place virtual content at a position that harmonizes with the environment based data, which has been learned in advance.

### Modified Example 2-2

In the second embodiment, information in which the position of the virtual content is known and the category is unknown is input into the object arrangement characteristic database in order to infer the category. However, information in which both the position and the category of the virtual content are unknown may be input into the object arrangement characteristic database in order to infer the position and the category.

As a result, it is possible to place virtual content at a position that harmonizes with the environment and to select a category that harmonizes with the environment, based on the data that has been learned in advance.

### Modified Example 2-3

In the second embodiment, the object arrangement characteristic database is a database in which object arrangement characteristics consisting of categories and three-dimensional positions of objects that exist in an environment are learned. However, a database in which elements relating to the appearance of the virtual content other than categories and three-dimensional positions were learned simultaneously may be used.

For example, an object arrangement characteristic database in which the color and size of the virtual content are added as elements may be created and used. By using such a database, elements relating to the appearance of the virtual content can be used as known information in order to infer other unknown information.

Additionally, both the category and the three-dimensional position of the virtual content, or either one thereof, may be used as known information, and elements relating to the appearance of the virtual content may be inferred as unknown information. Furthermore, all of the category, the three-dimensional position, and the elements relating to the appearance may be inferred as unknown information.

As described above, by creating and utilizing the object arrangement characteristic database, virtual content that harmonizes with the environment can be selected and placed in the environment based on the category, the three-dimensional position, and the elements relating to the appearance of the virtual content.

### Modified Example 2-4

Although in the present embodiment, one existing model is provided for each category, the present disclosure is not limited thereto, and a plurality of existing models for each category may be used. In a case in which there is a plurality of existing models for a category that corresponds to a prediction result of the category that was obtained by using the object arrangement characteristic database, for example, one of the plurality may be selected at random.

Alternatively, a plurality of existing models may be displayed on a user interface of the MR system 2, and one existing model may be selected by a user. As described above, by using a plurality of existing models for each category, an existing model to be used as virtual content can be selected from among more existing models.

### Third Embodiment

Although in the first embodiment, the virtual content is updated based on the degree of harmony between the real environment and the virtual content in order to update the virtual content to harmonize with the environment, calculation of the degree of harmony is not essential.

A prompt for updating virtual content to harmonize with the environment may be registered in advance and utilized. For example, to harmonize colors, a character string such as “set the colors closer to those of adjacent objects” may be used.

Additionally, to harmonize heights, a character string such as “set the height closer to that of adjacent objects” may be used. Alternatively, in a case in which the virtual content is a building, a character string such as “set the virtual content to be the same architectural style as surrounding buildings” may be used. By such a method, the virtual content can be updated to harmonize with the environment, similarly to a case in which the degree of harmony is calculated.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the information processing apparatus and the like through a network or various storage media. Then, a computer (or a CPU, an MPU, or the like) of the information processing apparatus and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2024-204301, filed on Nov. 22, 2024, which is hereby incorporated by reference herein in its entirety.

What is claimed is:

1. An information processing apparatus comprising:
at least one processor; and a memory coupled to the at least one processor, the memory storing instructions that, when executed by the at least one processor, cause the at least one processor to:
acquire environment information;
generate virtual content based on the environment information; and
update the virtual content to harmonize with the environment based on the environment information.

2. The information processing apparatus according to claim 1, wherein during updating a degree of harmony of the virtual content with respect to the environment is calculated based on the environment information, and the virtual content is updated to harmonize with the environment based on the degree of harmony.

3. The information processing apparatus according to claim 2, wherein during updating, the degree of harmony is calculated based on at least one of a color, a shape, a position, and an orientation of the virtual content and the environment information, and the virtual content is updated so that the degree of harmony becomes higher.

4. The information processing apparatus according to claim 1, wherein the environment information includes a position and a category of an object that exists in an environment.

5. The information processing apparatus according to claim 1, wherein, in the generating, the virtual content is generated based on a generation condition relating to at least one of a color, a shape, a position, and an orientation of the virtual content.

6. The information processing apparatus according to claim 1, wherein, in the generating, text information for generating the virtual content that harmonizes with the environment is generated based on the environment information, and the virtual content is generated based on the text information by using a generative AI model.

7. The information processing apparatus according to claim 1,
wherein the memory stores further instructions that, when executed by the at least one processor, cause the at least one processor to:
hold a plurality of virtual content models in association with a category and position information of an object; and
in the generating, select the virtual content from among the plurality of virtual content models based on the environment information.

8. An information processing method comprising:
acquiring environment information;
generating virtual content based on the environment information; and
updating the virtual content to harmonize with the environment based on the environment information.

9. A non-transitory computer-readable storage medium configured to store a computer program comprising instructions for executing the following processes:
acquiring environment information;
generating virtual content based on the environment information; and
updating the virtual content to harmonize with the environment based on the environment information.
